(19) United States
(12) Patent Application Publication
(10) Pub. No.: US 2026/0283114 A1
(43) Pub. Date: Sep. 24, 2026

(54) ELECTRONIC SOUND PUZZLE FOR PETS

(71) Applicant: The Kyjen Company, LLC, Centennial, CO (US)

(72) Inventors: Nina Ottosson, Karlskoga (SE); Danielle Salyer, Denver, CO (US); Chaz Ozzello, Englewood, CO (US); Jeffrey Paris, Los Angeles, CA (US); Meghan Higgins, Denver, CO (US); Graham Wilson, Denver, CO (US)

(21) Appl. No.: 19/577,078

(22) Filed: Mar. 24, 2026

Related U.S. Application Data
(60) Provisional application No. 63/776,826, filed on Mar. 24, 2025.

(51) Int. Cl. A01K 15/02

(52) U.S. Cl. CPC A01K 15/025; A01K 15/0201

(57) ABSTRACT

Provided is a pet toy including a housing having a sidewall with a first opening, a top surface, and a cavity. The pet toy further includes a first button and a second button disposed on the top surface of the housing; a first blocking surface next to the first opening inside the cavity and configured to block the opening; and a speaker in the sidewall wherein when the first button is depressed the speaker plays a first sound and the first blocking surface is lowered to unblock the first opening allowing the food to travel from the cavity through the first opening. When the second button is depressed, the speaker plays a second sound and the blocking surface is lowered to unblock the first opening allowing the food to travel from the cavity through the first opening.

This application claims priority to U.S. Provisional Application Ser. No. 63/776,826 entitled “Electronic Sound Puzzle For Pets”, filed Mar. 24, 2025, the entire disclosure of which is hereby incorporated by reference herein.

### BACKGROUND OF THE DISCLOSURE

### Field of the Disclosure

The disclosure relates generally to pet toys, and more specifically, to interactive pet toys configured to mentally stimulate pets.

### Brief Description of Related Technology

Generally, a wide variety of pet toys are available to keep pets entertained. For example, pet toys including one or more of a squeaker, a bell, crinkle paper, and the like may be configured to make noise, entertaining pets. Some pet toys engage and entertain pets by dispensing treats. Other pet toys include balls, frisbees, wands, toys including treats (e.g., cat nip, pet treats), chew toys, and the like. However, everyday noises such as a car horn, a baby crying, or a doorbell, for example, have a tendency to scare or agitate a pet, leading the pet to bark, meow, or make loud noises.

### SUMMARY OF THE DISCLOSURE

In accordance with one aspect of the present disclosure, a pet toy includes a housing having a sidewall with a first opening, a top surface, and a cavity disposed between the sidewall and the top surface. The cavity is configured to hold food and be in communication with the first opening. The pet toy further includes a first button on a first side of the top surface of the housing and includes a second button on a second side of the top surface of the housing, opposite the first button. The pet toy further includes a first blocking surface next to the first opening inside the cavity and configured to block the first opening when in a raised position. The first blocking surface is coupled to the first button and the second button. The pet toy further includes a speaker inside the sidewall. When the first button is depressed, the speaker plays a first sound and the first blocking surface is lowered to unblock the first opening, which allows the food to travel from the cavity through the first opening. Further, when the second button is depressed, the speaker plays a second sound, and the first blocking surface is lowered to unblock the first opening, which allows the food to travel from the cavity through the first opening.

In accordance with another aspect of the present disclosure, a pet toy includes a housing having a sidewall with an opening, a top surface and a cavity disposed between the sidewall and the top surface. The cavity is configured to hold food and be in communication with the opening. The pet toy further includes a button on the top surface of the housing. The pet toy further includes a blocking surface next to the opening inside the cavity and blocks the opening when in a raised position. The blocking surface is coupled to the button. The pet toy further includes a speaker inside the sidewall. When the button is depressed, the speaker plays a sound and the blocking surface is lowered to unblock the opening, which allows the food to travel from the cavity through the opening.

### BRIEF DESCRIPTION OF THE DRAWING FIGURES

For a more complete understanding of the disclosure, reference should be made to the following detailed description and accompanying drawing figures.

FIG. 1 illustrates a perspective view of a pet toy in accordance with one example of the present disclosure.

FIGS. 2A-2B illustrate a perspective view of a cavity of the pet toy of FIG. 1 coupled to a blocking surface in a lowered position, according to one embodiment.

FIGS. 3A-3B illustrate another perspective view of a cavity of the pet toy of FIG. 1 coupled to a blocking surface in a lowered position, according to one embodiment.

FIGS. 4A-4B illustrate two side views of the pet toy of FIG. 1 with a first button depressed (FIG. 4A) and a second button depressed (FIG. 4B), according to one embodiment.

FIGS. 5A-5B illustrate two side views of the pet toy of FIG. 1 with a third button depressed (FIG. 5A) and a fourth button depressed (FIG. 5B), according to one embodiment.

FIG. 6 illustrates a top portion and a bottom portion of the housing.

FIG. 7 illustrates a top view of the pet toy of FIG. 1 showing a pet toy including four buttons, according to one embodiment.

FIG. 8 illustrates another perspective view of the pet toy of FIG. 1, according to an embodiment.

FIG. 9 illustrates a perspective view of a pet toy in accordance with another example of the present disclosure.

FIG. 10 illustrates a bottom perspective view of the pet toy of FIG. 9 according to an embodiment.

FIG. 11 illustrates a cross-sectional side view of the pet toy of FIG. 10 according to one example.

FIG. 12 is another perspective view of the pet toy of FIG. 9 illustrating the removable lid.

FIGS. 13A and 13B illustrate cross-sectional side views of the pet toy of FIG. 10 in a button resting state (FIG. 13A) and a button depressed state (FIG. 13B).

While the disclosed pet toys and methods are susceptible of embodiments in various forms, there are illustrated in the drawings (and will hereafter be described) specific embodiments of the disclosure, with the understanding that the disclosure is intended to be illustrative and is not intended to limit the disclosure to the specific embodiments described and illustrated herein.

### DETAILED DESCRIPTION OF THE DISCLOSURE

The present disclosure is provided to solve the above-mentioned problems in the Background of the Disclosure section. Pets have a tendency to get scared or agitated and thus react to loud noises or stimuli such as car horns, doorbells, sirens, or babies crying. A pet's behavior and reaction to such stimuli can be changed through desensitization and counterconditioning. Desensitization is a technique in which an animal is systematically exposed to a trigger stimulus until the stimulus no longer triggers a response. Counterconditioning is a technique in which a stimulus that creates a negative emotional response is paired with something known to create a positive emotional response in the animal. Typically, food or pet treats can be used to create a positive emotion, or toys and games can be used to create positive emotions. By combining the techniques of counterconditioning with desensitization, a pet can become accustomed to certain stimuli that would cause them to become agitated. In this regard, a pet can be exposed to stimuli multiple times, and then be rewarded with a treat, in order to train the pet and keep the pet from reacting negatively to the stimulus.

Therefore, there is a need for a toy that can perform this technique for pets. Specifically, there is a need for new and unique pet toys that provide a learning tool for a pet to acclimate to everyday noises. In one example of such a pet toy, the pet toy includes interactive components that mix potentially negative sounds (i.e., negative stimuli) with treats to create a positive emotion or reaction to the sounds. For instance, when a pet presses a button, a stimulus will play from a speaker (e.g., a doorbell sound), and a treat will come out of the toy. In this regard, the pet can be trained to have a positive reaction to certain stimuli and become desensitized to the stimuli (e.g., loud or otherwise evocative noise).

The present disclosure provides such a solution by combining negative stimuli (e.g., noises or sounds) with positive feedback (e.g., food) through an interactive electronic sound puzzle. Specifically, the present disclosure provides an interactive pet toy including a housing having a sidewall with a first opening for food (e.g., treats, kibble, and the like), a top surface, and a cavity between the sidewall and the top surface, where the cavity holds the food for pets. The pet toy further includes one or more buttons that when pressed by a pet, causes a sound to be played and also causes food to be dispensed through the opening. The sound, or sounds, are emitted through a speaker in the sidewall, and the sound may be pre-programmed sounds or may be customizable (e.g., by having a user such as a pet owner record sounds of their choosing). When there are multiple buttons, each button may correspond to a different sound.

In one example, the disclosed interactive pet toy or electronic puzzle includes four buttons, where each button corresponds to a particular sound, such as a baby crying, a doorbell, fireworks, and a police siren. The disclosed pet toy includes a central body or cavity for holding food and two openings, one on each end of the pet toy, for the food to be dispensed through. In this example, two of the four buttons on one side or end of the pet toy are associated with one of the two openings and the other two buttons on the other side or end of the pet toy are associated with the other of the two openings. Thus, depending on which button is depressed, a sound will play and food will be dispensed from one of the two openings. The disclosed pet toy may also include trays disposed on each end of the toy to capture food dispensed for the openings. In another example, the disclosed interactive pet toy or electronic sound puzzle system is a modular system consisting of one or more single button pet toys, where each single button pet toy includes one button associated with a particular sound, a body having a cavity, an opening in the body for food to be dispensed through, and a tray to collect the dispensed food. In this example, two or more of the single button pet toys can be joined together to create a multiple-button pet toy system.

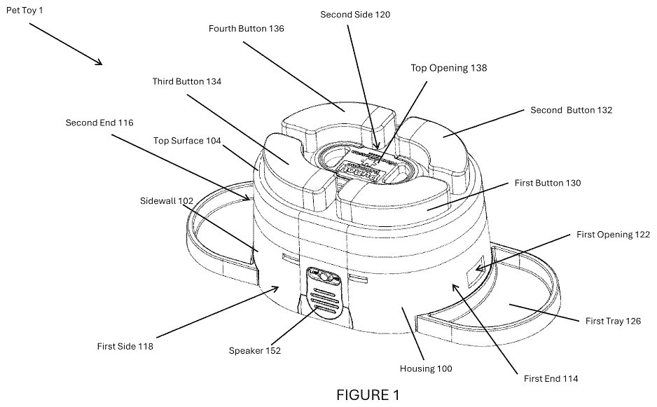

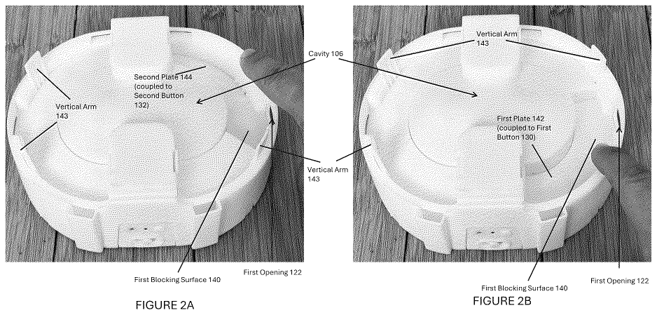

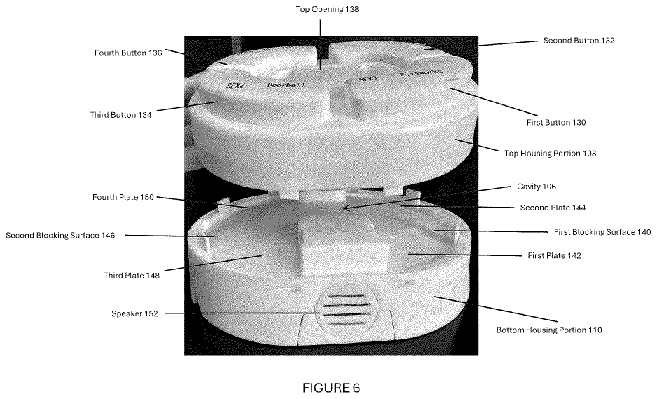

Referring to FIG. 1, a perspective view of a pet toy 1 according to one example of the present disclosure is illustrated. The pet toy 1 includes a housing 100. The housing 100 includes a sidewall 102, a top surface 104, and a cavity 106 (shown in FIGS. 2, 3, and 6). The housing 100 may include a top housing portion 108 and a bottom housing portion 110 as shown in FIG. 6. The top housing portion 108 and the bottom housing portion 110 may be coupled together to form the complete housing 100. The top housing portion 108 may include tabs that can be snapped into corresponding holes on the bottom housing portion 110. This allows easy access for cleaning and repairs if the need may arise.

The housing 100 further includes a first end 114 and a second end 116, wherein the first end 114 is on one side of the sagittal plane, while the second end 116 is on the opposite side of the sagittal plane, opposite the first end 114. The housing 100 includes a first side 118 and a second side 120, wherein the first side 118 is on one side of a coronal plane, while the second side 120 is on the opposite side of the coronal plane, opposite the first side 118.

The sidewall 102 extends upwards from a base portion of the pet toy 1 to form the cavity 106 in the middle of the surrounding sidewall 102. In the example shown in FIG. 1, the sidewall 102 is one continuous wall that forms the perimeter of the cavity 106 and is shaped like an oval. Other embodiments may include a sidewall 102 including multiple sides and multiple shapes, such as a rectangle, square, diamond, circle, trapezoid, hexagon, and the like. The top housing portion 108 may further include a clear window to see into the cavity 106. A pet may see the food that is inside the pet toy 1 and be further incentivized to engage with the pet toy 1. Additionally, the pet may be able to smell the food inside the toy 1 and be further incentivized to engage with the toy 1.

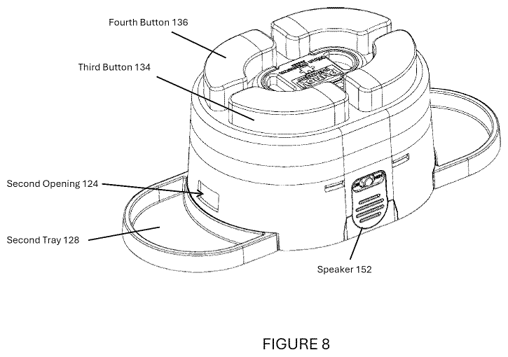

The sidewall 102 further includes a first opening 122 on a first end 114 of the housing 100. The sidewall 102 may include a second opening 124 on a second end 116 of the housing 100, opposite the first opening 122, as shown in FIG. 8. The first opening 122 and the second opening 124 are in communication with the cavity 106.

The cavity 106, as seen in FIGS. 2A-2B, 3A-3B, and 6, is between the sidewall 102 and the top surface 104 of the housing 100. The top housing portion 108 and the bottom housing portion 110 each surround the cavity 106. Pet food can be stored in the cavity 106 and when the pet interacts with the pet toy 1, the food will travel from the cavity 106 through either the first opening 122 or the second opening 124 for the pet to consume.

The sidewall 102 may further include a first tray 126 and a second tray 128 removably attached to the outer surface of the sidewall 102. The first tray 126 is adjacent to the first opening 122. When the food exits the first opening 122, the first tray 126 catches the food and allows easy access to a pet to consume the food (e.g., treat). The second tray 128 is adjacent to the second opening 124, opposite the first tray 128. When the food exits the second opening 124, the second tray 128 catches the food and allows easy access to a pet to consume the food.

The top surface 104 of the housing 100 is located on the top housing portion 108. In one embodiment shown in FIG. 1, the top surface 104 includes a first button 130, a second button 132, a third button 134, and a fourth button 136. The first button 130 and second button 132 may be located on the first end 114 of the housing 100. The third button 134 and the fourth button 136 may be located on the second end 116 of the housing 100. The first button 130 and the third button 134 may be disposed on the first side 118 of the housing 100. The second button 132 and the fourth button 136 may be disposed on the second side 120 of the housing 100, opposite the first button 130 and third button 134. The first button 130, the second button 132, the third button 134, and the fourth button 136 may be, but not limited to, a spherical shape, a round shape, a rectangular shape, and/or the like, or a combination thereof. The first button 130, the second button 132, the third button 134, and the fourth button 136 are spring loaded; therefore once the button is depressed, it returns to the raised position.

The top surface 104 may further include a top opening 138 that is in communication with the cavity 106 to load the food into the cavity 106. The top opening 138 may include a top covering that allows the top opening 138 to be opened and closed. The top covering also allows the food to be covered, so the pet cannot access the food without playing with the toy. The top covering includes pieces that a user (pet owner) can grab to open the top opening 138.

Referring to FIGS. 2A-2B, a perspective view of a cavity 106 of the pet toy 1 of FIG. 1 coupled to a first blocking surface 140 in a lowered position, according to one embodiment is illustrated. The pet toy 1 further includes a first internal ramp or a first blocking surface 140 next to the first opening 122 inside the cavity 106. When the first blocking surface 140 is raised, the first opening 122 is covered. When the first blocking surface 140 is lowered, the first opening 122 is open. The first blocking surface 140 is located in the bottom housing portion 110. The bottom housing portion 110 includes a first plate 142 that is coupled to the first blocking surface 140. The first plate 142 is further coupled to the first button 130 on the top housing portion 108 of the housing 100 via a vertical arm 143. When the top housing portion 108 and the bottom housing portion 110 are coupled together, the first button 130 can be depressed to lower the first plate 142, which is coupled to the first blocking surface 140 and thus lowers the first blocking surface 140 and allows the food to exit the cavity 106 through the first opening 122. In this way, the first button 130 may be coupled to the first blocking surface 140.

The bottom housing portion 110 further includes a second plate 144 that is coupled to the first blocking surface 140 on the opposite side of the first plate 142. The second plate 144 is further coupled to the second button 132 on the top housing portion 108 via a vertical arm 143. When the top housing portion 108 and the bottom housing portion 110 are coupled together, the second button 132 can be depressed to lower the second plate 144, which is coupled to the first blocking surface 140 and thus lowers the first blocking surface 140 and allows the food to exit the cavity 106 through the first opening 122. In this way, the second button 132 may also be coupled to the first blocking surface 140.

The first plate 142 and the second plate 144 are each coupled to the first blocking surface 140 on opposite sides. The first plate 142 is coupled to the first blocking surface 140 on the first side 118 of the housing 100, while the second plate 144 is coupled to the first blocking surface 140 on the second side 120 of the housing 100. When the first plate 142 is depressed, the first blocking surface 140 is lowered with the first plate 142, while the second plate 144 remains raised. When the second plate 144 is depressed, the first blocking surface 140 is lowered with the second plate 144, while the first plate 142 remains raised. The first plate 142, the second plate 144, and the first blocking surface 140 surround the cavity 106 on its perimeter.

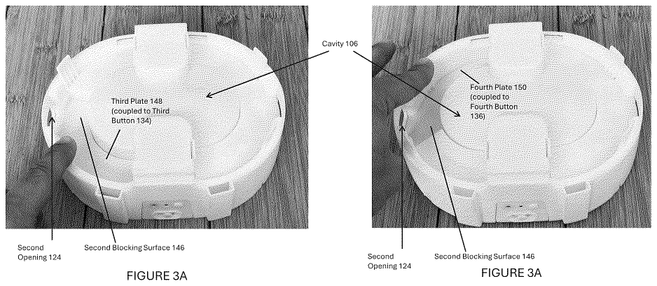

Referring to FIGS. 3A-3B, a perspective view of a cavity 106 of the pet toy 1 of FIG. 1 coupled to a second blocking surface in a lowered position, according to one embodiment is illustrated. The pet toy 1 further includes a second internal ramp or a second blocking surface 146 next to the second opening 124 inside the cavity 106. When the second blocking surface 146 is raised, the second opening 124 is covered. When the second blocking surface 146 is lowered, the second opening 124 is open. The second blocking surface 146 is located in the bottom housing portion 110. The bottom housing portion 110 includes a third plate 148 that is coupled to the second blocking surface 146. The third plate 148 is further coupled to the third button 134 on the top housing portion 108 via a vertical arm 143. When the top housing portion 108 and the bottom housing portion 110 are coupled together, the third button 134 can be depressed to lower the third plate 148, which is coupled to the second blocking surface 146 and thus lowers the second blocking surface 146 and allows the food to exit the cavity 106 through the second opening 124. In this way, the third button 134 may be coupled to the second blocking surface 146.

The bottom housing portion 110 further includes a fourth plate 150 that is coupled to the second blocking surface 146 on the opposite side of the third plate 148. The fourth plate 150 is further coupled to the fourth button 136 on the top housing portion 108 via a vertical arm 143. When the top housing portion 108 and the bottom housing portion 110 are coupled together, the fourth button 136 can be depressed to lower the fourth plate 150, which is coupled to the second blocking surface 146 and thus lowers the second blocking surface 146 and allows the food to exit the cavity 106 through the second opening 124. In this way, the fourth button 136 may also be coupled to the second blocking surface 146.

The third plate 148 and the fourth plate 150 are each coupled to the second blocking surface 146 on opposite sides. The third plate 148 is coupled to the second blocking surface 146 on the first side 118 of the housing 100, while the fourth plate 150 is coupled to the second blocking surface 146 on the second side 120 of the housing 100. When the third plate 148 is depressed, the second blocking surface 146 is lowered with the third plate 148, while the fourth plate 150 remains raised. When the fourth plate 150 is depressed, the second blocking surface 146 is lowered with the fourth plate 150, while the third plate 148 remains raised. The third plate 148, the fourth plate 150, and the second blocking surface 146 surround the cavity 106 on its perimeter.

The cavity 106, as shown in FIGS. 2A-2B and 3A-3B, may contain a slanted floor, to allow the food to slide, roll, or fall out the first opening 122 or the second opening 124 more easily. Additionally, the first plate 142 and the second plate 144 may contain a slanted floor, slanted towards the first blocking surface 140, to allow the food to roll out the first opening 122 when the first button 130 or second button 132 is depressed. Further, the third plate 148 and the fourth plate 150 may contain a slanted floor, slanted towards the second blocking surface 146, to allow the food to roll out the second opening 124 when the third button 134 or fourth button 136 is depressed. The first plate 142, the second plate 144, the third plate 148, and the fourth plate 150 are spring loaded, so when the plates are depressed by the respective buttons (i.e., the first button 130, the second button 132, the third button 134, or the fourth button 136), the plates return the first blocking surface 140 or the second blocking surface 146 to a raised position once the button is released.

Returning to FIG. 1, the pet toy 1 further includes a speaker 152 in the sidewall 102. The speaker 152 may be made of electronic components in the bottom housing portion 110. The electronic components may include a printed circuit board (PCB), switches, wires and a power source (i.e., battery powered or a plug-in for an electrical outlet). The electronic components also include a microphone and memory to hold user-made sounds. The microphone may be used to program the first button 130, the second button 132, the third button 134, or the fourth button 136 to play a user-made sound. Any of the first button 130, the second button 132, the third button 134, or the fourth button 136 may be programmable to play the user-made sound.

The sidewall 102 further includes a power switch, a record button, and a record indicator LED light. The power switch allows the user (pet owner) to turn the power switch to a standard setting or a user mode. In the standard mode, the pre-programmed sounds (i.e., baby crying, siren, fireworks, or doorbell ringing) for each button are played when each button is depressed. In the user mode, the buttons will play a user-recorded sound. The record button allows a user to record the user-made sounds.

In order to record the user made sounds, a user (pet owner) slides the power switch to the user mode. The user then will press the record button for three seconds. After three seconds, a beep sound effect will play, and the record indicator LED will light up. The pet toy is now in record mode, and the record button can be released. To record a user made sound while in record mode, one of the buttons is depressed while the user provides a sound to be recorded. Once the button is released, the sound has been recorded. Multiple buttons can be programmed while in record mode. In order to exit record mode, the record button is pressed once again, and the LED light will turn off.

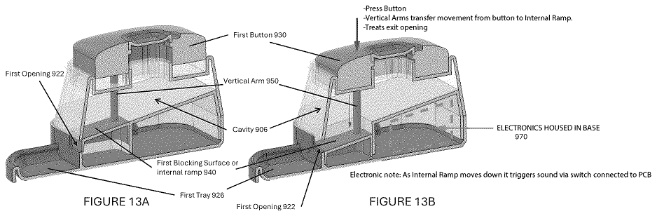

The electronic components may also include electronic switches that are connected to the first plate 142, the second plate 144, the third plate 148, and the fourth plate 150, such that when the first button 130 is depressed, the first plate 142 is lowered that activates the electronic switch to play a first sound from the speaker 152. When the second button 132 is depressed the second plate 144 is lowered that activates the electronic switch to play a second sound from the speaker 152. When the third button 134 is depressed, the third plate 148 is lowered that activates the electronic switch to play a third sound from the speaker 152. When the fourth button 136 is depressed, the fourth plate 150 is lowered that activates the electronic switch to play a fourth sound from the speaker 152. The electronic components are housed in the base of the pet toy 1 (see FIG. 13B, for example), including a PCB and one or more switches connected to the PCB. As discussed above, depressing a button causes the vertical arms and plates to move downward, which causes the ramps or blocking surfaces to be depressed, which triggers sounds via a switch connected to the PCB and allows food to pass through the openings.

The first sound, the second sound, the third sound, or the fourth sound may include but is not limited to a baby crying, a siren, a doorbell ringing, fireworks exploding, plates crashing, doors shutting, a car horn, a car starting, and/or the like, and combinations thereof. The sound may be any noise that agitates a pet and can be personalized to what agitates a specific pet. The pet toy is pre-programmed to play a baby crying, a siren, a doorbell ringing, and fireworks. A user is able to program a user made sound into the toy. By being able to program a user-made sound, the specific stimulus that agitates a pet may be used in order to desensitize the pet to the specific sound. User-made sounds can include loud yelling, talking, music, dishes breaking, furniture falling, doorbell ringing, doors opening, and/or the like, or any combination thereof.

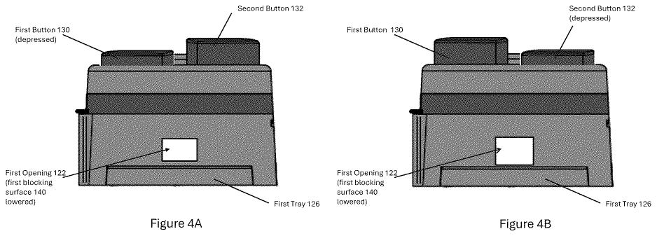

Referring to FIGS. 4A and 4B, two side views of the pet toy 1 of FIG. 1 with a first button 130 depressed and a second button 132 depressed, according to one embodiment, are illustrated. When the first button 130 is depressed (as shown in FIG. 4A), the speaker 152 plays a first sound and the first blocking surface 140 is lowered to unblock the first opening 122 allowing the food to travel from the cavity 106 through the first opening 122. When the second button 132 is depressed (as shown in FIG. 4B), the speaker 152 plays a second sound, and the first blocking surface 140 is lowered to unblock the first opening 122 allowing the food to travel from the cavity 106 through the first opening 122.

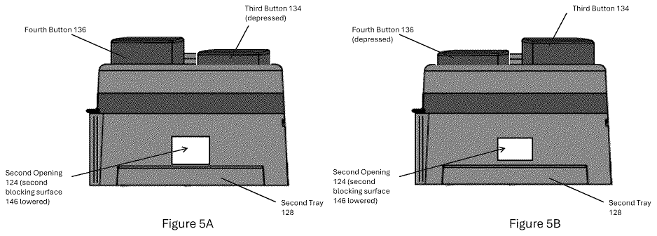

Referring to FIGS. 5A and 5B, two side views of the pet toy of FIG. 1 with a third button 134 depressed and a fourth button 136 depressed, according to one embodiment, are illustrated. When the third button 134 is pressed (as shown in FIG. 5A), the speaker 152 plays a third sound and the second blocking surface 146 is lowered to unblock the second opening 124 allowing the food to travel from the cavity 106 through the second opening 124. When the fourth button 136 is depressed (as shown in FIG. 5B), the speaker 152 plays a fourth sound and the second blocking surface 146 is lowered to unblock the second opening 124 allowing the food to travel from the cavity 106 through the second opening 124.

Referring to FIG. 6, a top housing portion 108 and a bottom housing portion 110 are further illustrated. The top housing portion 108 and the bottom housing portion 110 are coupled together to allow the first button 130, the second button 132, the third button 134, and the fourth button 136 to be in communication with the respective plates.

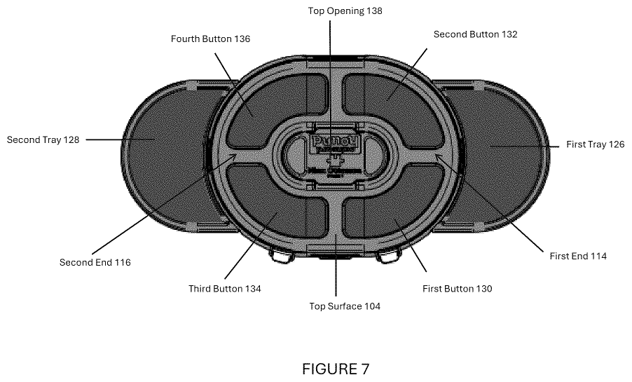

Referring to FIG. 7, a top view of the pet toy 1 of FIG. 1 shows all four buttons, according to one embodiment. The sidewall 102 of the housing 100 may further include a first tray 126 and a second tray 128.

Referring to FIG. 8, another perspective view of the pet toy 1 of FIG. 1, according to an embodiment, is illustrated. The pet toy 1 may further include a second opening 124 on the second end 116 of the housing 100.

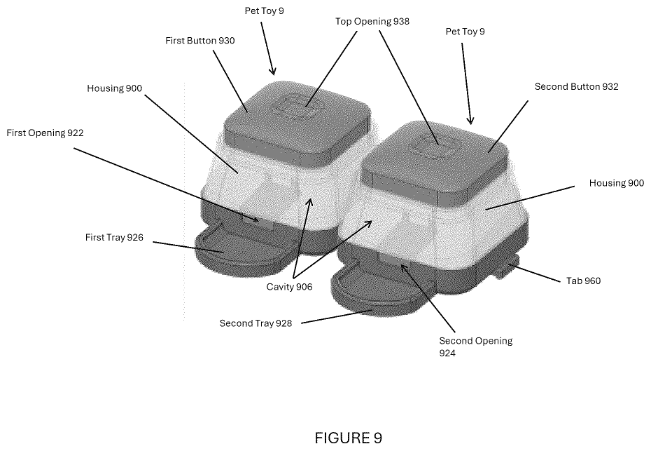

Referring to FIG. 9, a perspective view of a pet toy system in accordance with another example of the present disclosure is illustrated. In the example shown in FIG. 9, an interactive pet toy or electronic sound puzzle system is a modular system consisting of one or more single button pet toys 9, where each single button pet toy 9 includes one button associated with a particular sound, a body having a cavity, an opening in the body for food to be dispensed through, and a tray to collect the dispensed food. In this example, two or more of the single button pet toys can be joined together to create a multiple-button pet toy system. The individual pet toys 9 shown in FIGS. 9-13 are substantially the same, and function substantially the same, as the pet toy 1 disclosed and described above with reference to FIGS. 1-8. For example, FIG. 9 illustrates a first pet toy 9 having a first button 930, a top opening 938 in the first button 930, a housing 900, a cavity 906 inside the housing 900, a first opening 922 in the housing 900, and a first tray 926. Similarly, a second pet toy 9 includes a second button 932, a top opening 938 in the second button 932, a housing 900, a cavity 906 inside the housing 900, a second opening 924 in the housing 900, and a second tray 928. The first and second pet toys 9 may be coupled together to form a two-button pet toy 9. While FIG. 9 shows two pet toys 9 coupled together, more than two pet toys 9 can be joined together to form a matrix of multiple pet toys 9.

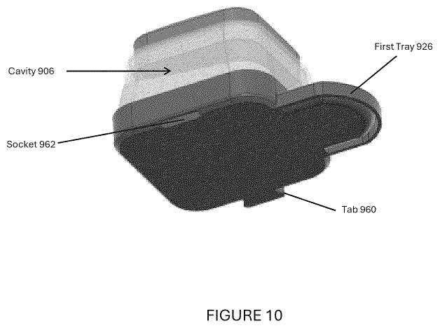

FIG. 10 illustrates a bottom perspective view of the pet toy 9 of FIG. 9 according to an embodiment. The bottom of the housing 900 of the pet toys 9 also include a ridge, projection, or tab 960 off one side of the housing 900 and a cavity, depression or socket 962 in the other side of the housing 900 for connecting to adjacent pet toys 9. For example, the tab 960 of a first pet toy 9 fits into the socket 962 of another pet toy 9 to join the two pet toys 9 together.

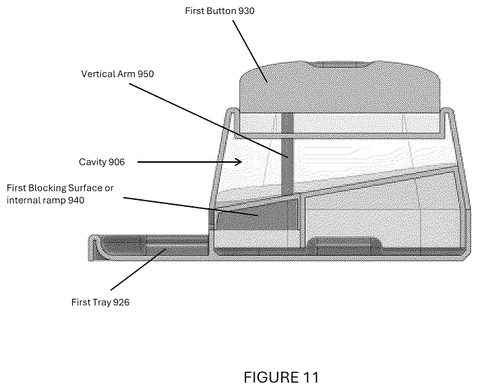

FIG. 11 illustrates a cross-sectional side view of the pet toy 9 of FIG. 10 according to one example. Similar to the pet toy 1 described above, and as shown in FIG. 11, the first button 930 is connected to a vertical arm 950, which is connected to an internal ramp 940 (similar to the blocking surfaces described above). As shown in FIG. 11, both the cavity 906 and internal ramp 940 have a slanted floor, to allow the food to slide, roll, or fall out the first opening 922 more easily when the first button 930 is depressed.

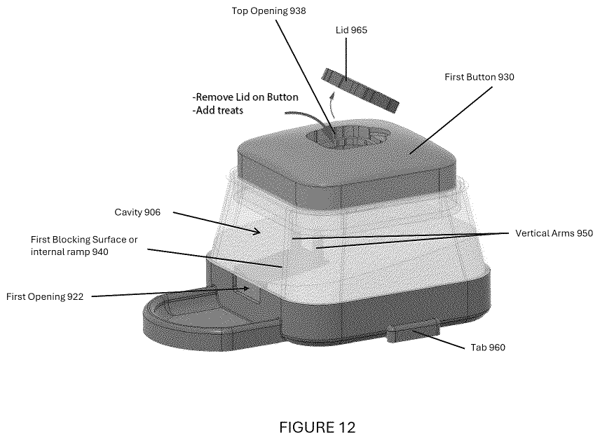

FIG. 12 is another perspective view of the pet toy 9 of FIG. 9 illustrating a removable cap or lid 965. The lid 965 is removed from the top opening 938 to fill the cavity 906 with food. FIG. 12 also shows the slanted or sloped surfaces of the cavity 906 and ramp 940.

FIGS. 13A and 13B illustrate cross-sectional side views of the pet toy of FIG. 10 in a button resting state (FIG. 13A) and a button depressed state (FIG. 13B). FIG. 13A depicts the pet toy 9 in a resting state, with the first button 930 in a resting or non-depressed state (i.e., first position). As shown in FIG. 13B, pressing the first button 930 downward (to a depressed state, or second position) drives the vertical arm 950 downward, which transfers motion to the internal ramp 940. This movement lowers the ramp 940 and allows treats that have accumulated above the ramp 940 in the cavity 906 to exit through the first opening 922 into the first tray 926. Also shown in FIG. 13B is the area where the electronics 970 are housed in the bottom housing of the pet toy 9. The movement of the ramp 940 triggers the sound via a switch connected to the PCB, which is part of the electronics 700. Similar to the sounds described above, the sounds can be predetermined and pre-set on the pet toy 9 or customizable by a user.

By combining a negative stimulus (i.e., loud noises) with a positive reinforcement (i.e., treats or kibble) a pet can be trained and keep the pet from reacting negatively to the stimulus.

It should be understood that, although the terms first, second, etc. may be used herein to describe various elements, components, regions, levels, layers, and/or sections, these elements, components, regions, levels, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

While the present disclosure has been described with reference to specific examples, which are intended to be illustrative only and not to be limiting of the disclosure, it should be apparent to those of ordinary skill in the art that changes, additions and/or deletions may be made to the disclosed embodiments without departing from the spirit and scope of the disclosure.

The foregoing description is given for clarity of understanding only, and no unnecessary limitations should be understood therefrom, as modifications within the scope of the disclosure may be apparent to those having ordinary skill in the art.

When a component, device, element, or the like of the present disclosure is described as having a purpose or performing an operation, function, or the like, the component, device, or element, should be considered herein as being “configured to” meet that purpose or perform that operation or function.

What is claimed is:

1. A pet toy comprising:
a housing including:
a sidewall that includes a first opening;
a top surface; and
a cavity disposed between the sidewall and the top surface, the cavity being configured to hold food and be in communication with the first opening;
a first button disposed on a first side of the top surface of the housing;
a second button disposed on a second side of the top surface of the housing opposite the first side;
a first blocking surface disposed adjacent to the first opening inside the cavity and configured to block the first opening in a raised position, wherein the first blocking surface is coupled to the first button and the second button; and
a speaker disposed in the sidewall,
wherein when the first button is depressed, the speaker plays a first sound and the first blocking surface is lowered to unblock the first opening allowing the food to travel from the cavity through the first opening, and
wherein when the second button is depressed, the speaker plays a second sound and the first blocking surface is lowered to unblock the first opening allowing the food to travel from the cavity through the first opening.

2. The pet toy of claim 1, wherein the housing includes a top housing portion and a bottom housing portion coupled together.

3. The pet toy of claim 1, further comprising a first tray removably attached to an outer surface of the sidewall adjacent to the first opening.

4. The pet toy of claim 1, wherein the top surface includes a top opening in communication with the cavity to load the food into the cavity.

5. The pet toy of claim 1, wherein the housing includes a first end and a second end.

6. The pet toy of claim 5, wherein the first button and the second button are disposed on the first end of the housing.

7. The pet toy of claim 6, further comprising a third button and a fourth button disposed on the second end of the housing, wherein the third button is disposed on the first side of the top surface of the housing and the fourth button is disposed on the second side of the top surface of the housing.

8. The pet toy of claim 7, wherein the first opening is disposed on the first end of the housing, and wherein the sidewall further includes a second opening disposed on the second end of the housing, the second opening being in communication with the cavity.

9. The pet toy of claim 8, further comprising a second blocking surface disposed adjacent to the second opening inside the cavity, wherein the second blocking surface is coupled to the third button and the fourth button.

10. The pet toy of claim 9, wherein when the third button is depressed, the speaker plays a third sound and the second blocking surface is lowered to unblock the second opening allowing the food to travel from the cavity through the second opening.

11. The pet toy of claim 9, wherein when the fourth button is depressed, the speaker plays a fourth sound and the second blocking surface is lowered to unblock the second opening allowing the food to travel from the cavity through the second opening.

12. The pet toy of claim 9, further comprising a second tray disposed on the outer surface of the sidewall adjacent to the second opening.

13. The pet toy of claim 11, wherein any of the first button, the second button, the third button, or the fourth button are programmable to play a user-made sound.

14. A pet toy comprising:
a housing including:
a sidewall that includes an opening;
a top surface; and
a cavity disposed between the sidewall and the top surface, the cavity being configured to hold food and be in communication with the opening;
a button disposed on the top surface of the housing;
a blocking surface disposed adjacent to the opening inside the cavity and configured to block the opening in a raised position, wherein the blocking surface is coupled to the button; and
a speaker disposed in the sidewall,
wherein when the button is depressed, the speaker plays a sound and the blocking surface is lowered to unblock the opening allowing the food to travel from the cavity through the opening.

15. The pet toy of claim 14, wherein the housing includes a top housing portion and a bottom housing portion coupled together.

16. The pet toy of claim 14, further comprising a tray removably attached to an outer surface of the sidewall adjacent to the opening.

17. The pet toy of claim 14, wherein the button is programmable to play a user-made sound.

18. A pet toy system comprising:
a first pet toy including:
a first housing having:
a first sidewall that includes a first opening;
a first top surface;
a first inner wall extending between opposite sides of the first sidewall, such that the first inner wall defines a first internal chamber between the first inner wall and the first top surface, the first internal chamber being in communication with the first opening in the first sidewall and configured to hold pet food;
a first tab extending away from a bottom surface of the first housing; and
a first socket disposed in the bottom surface of the first housing;
a first button disposed on the first top surface of the first housing; and
a first ramp disposed adjacent to the first opening inside the first internal chamber and configured to block the first opening in a raised position, wherein the first ramp is coupled to the first button by a first vertical arm, wherein when the first button is depressed, the first ramp is lowered to unblock the first opening allowing the food to travel from the first internal chamber through the first opening; and
a second pet toy including:
a second housing having:
a second sidewall that includes a second opening;
a second top surface;
a second inner wall extending between opposite sides of the second sidewall, such that the second inner wall defines a second internal chamber between the second inner wall and the second top surface, the second internal chamber being in communication with the second opening in the second sidewall and configured to hold pet food;
a second tab extending away from a bottom surface of the second housing; and
a second socket disposed in the bottom surface of the second housing;
a second button disposed on the second top surface of the second housing; and
a second ramp disposed adjacent to the second opening inside the second internal chamber and configured to block the second opening in a raised position, wherein the second ramp is coupled to the second button by a second vertical arm, wherein when the second button is depressed, the second ramp is lowered to unblock the second opening allowing the food to travel from the second internal chamber through the second opening,
wherein the first tab and the second tab are configured to be engaged with the second socket and the first socket, respectively, to couple the first pet toy and the second pet toy.
